(19) United States
(12) Patent Application Publication
(10) Pub. No.: US 2006/0293435 A1
(43) Pub. Date: Dec. 28, 2006

(54) Light-emitting diode assembly housing comprising high temperature polyamide compositions

(76) Inventors: Marvin M. Marens, Vienna, WV (US); Georgios Topoulos, Geneva (CH)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/449,295

(22) Filed: Jun. 8, 2006

Related U.S. Application Data
(60) Provisional application No. 60/689,772, filed on Jun. 10, 2005.

(51) Int. Cl. C08K 3/22; C08G 69/26

(52) U.S. Cl. 524/497; 524/606; 523/200

(57) ABSTRACT

Light-emitting diode assembly housing comprising high temperature polyamide compositions containing titanium dioxide and, optionally, one or more fillers and/or reinforcing agents and one or more oxidative stabilizers.

### CROSS REFERENCE TO RELATED APPLICATIONS

This application claims the benefit of priority to U.S. Provisional Application No. 60/689,772, filed Jun. 10, 2005.

### FIELD OF THE INVENTION

The present invention relates to light emitting diode assembly components comprising high temperature polyamide compositions containing titanium dioxide.

### BACKGROUND OF THE INVENTION

Light-emitting semiconductor diodes (LED's) are increasingly being used as light sources in numerous applications due to their many advantages over traditional light sources. LED's generally consume significantly less power than incandescent and other light sources, require a low voltage to operate, are resistant to mechanical shock, require low maintenance, and generate minimal heat when operating. As a result, they are displacing incandescent and other light sources in many uses and have found applications in such disparate areas as traffic signals, large area displays (including video displays), interior and exterior lighting, cellular telephone displays, automotive displays, and flashlights.

LED's are typically used in such applications as components in assemblies. LED assemblies comprise a housing partially surrounding at least one LED and an electrical connection between the diode and an electrical circuit. The assembly may further comprise a lens that is adhered to the housing and that fully or partially covers the LED and serves to focus the light emitted by the LED.

It would be desirable to make LED housings from polymeric materials, as such materials may be injection molded and offer considerable design flexibility. However, useful polymeric compositions would preferably satisfy a number of conditions. Since many LED assemblies are attached to circuits boards using reflow oven welding processes that operate at elevated temperatures, useful compositions would be sufficiently heat resistant to withstand the welding conditions and minimal surface blistering of the housing during the welding process. Useful compositions would further preferably exhibit good whiteness/reflectivity to maximize the amount of light reflected by the housing, have good ultraviolet light resistance, good long-term resistance to the operating temperatures of the LED assembly, and have good adhesion to any lens material used. The polyamide compositions used in the present invention satisfy the foregoing requirements.

WO 03/085029 discloses a resin composition useful in the production of light-emitting diode reflectors.

### SUMMARY OF THE INVENTION

There is disclosed herein a light-emitting diode assembly housing comprising a polyamide composition, comprising:

(a) about 40 to about 95 weight percent of at least one polyamide having a melting point of greater than about 270° C. and comprising repeat units derived from:
(i) dicarboxylic acid monomers comprising terephthalic acid, and, optionally, one or more additional aromatic and/or aliphatic dicarboxylic acids;
(ii) diamine monomers comprising one or more aliphatic diamines having 10 to 20 carbon atoms, and, optionally, one or more additional diamines; and
(iii) optionally, one or more aminocarboxylic acids and/or lactams;

(b) about 5 to about 40 weight percent of titanium dioxide;

(c) 0 to about 40 weight percent of at least one inorganic reinforcing agent or filler; and

(d) 0 to about 3 weight percent of at least one oxidative stabilizer, wherein the weight percentages are based on the total weight of the composition.

### DETAILED DESCRIPTION OF THE INVENTION

As used herein, by the terms “light-emitting diode assembly” or “LED assembly” is meant a device comprising at least one light-emitting semiconductor diode, an electrical connection capable of connecting the diode to an electrical circuit, and a housing partially surrounding the diode. The LED assembly may optionally have a lens that fully or partially covers the LED.

The LED assembly housing comprises a polyamide composition comprising at least one polyamide having a melting point of greater than about 270° C., titanium dioxide, and optionally, at least one reinforcing agent, stabilizers, and other additives.

The polyamide comprises repeat units derived from polymerizing terephthalic acid monomers and one or more aliphatic diamine monomers having 10 to 20 carbon atoms. The polyamide can optionally further include other repeat units derived from one or more additional saturated or aromatic dicarboxylic acid monomers and/or other aliphatic diamine monomers.

Suitable examples of additional dicarboxylic acid monomers include, but are not limited to, isophthalic acid, dodecanedioic acid, sebacic acid, and adipic acid. The terephthalic acid monomers will comprise about 75 to 100 mole percent, or preferably from about 80 to about 95 mole percent of the dicarboxylic acid monomers used to make the polyamide. As will be understood by those skilled in the art, the polyamide of this invention may be prepared from not only the dicarboxylic acids, but their corresponding carboxylic acid derivatives, which can include carboxylic acid esters, diesters, and acid chlorides, and as used herein, the term “dicarboxylic acid” refers to such derivatives as well as the dicarboxylic acids themselves.

The aliphatic diamine monomers may be linear or branched. Preferred aliphatic diamines are 1,10-diaminodecane and 1,12-diaminododecane. Additional aliphatic diamine monomers will preferably have fewer than 10 carbon atoms. Suitable examples include, but are not limited to, hexamethylenediamine and 2-methyl-1,5-pentanediamine. The one or more aliphatic diamines with 10 to 20 carbons will comprise about 75 to 100 mole percent, or preferably, about 80 to about 100 mole percent of the diamine monomers used to make the polyamide.

The polyamide can further optionally include repeat units derived from one or more aminocarboxylic acids (or acid derivatives such as esters or acid chlorides, and which are included in the term “aminocarboxylic acids” as used herein) and/or lactams. Suitable examples include, but are not limited to, caprolactam, 11-aminoundecanoic acid, and laurolactam. If used, the one or more aminocarboxylic acids and lactams will preferably comprise about 1 to about 25 mole percent of the total monomers used to make the polyamide.

Examples of suitable polyamides include, but are not limited to, one or more of polyamides derived from: terephthalic acid and 1,10-diaminodecane; terephthalic acid, isophthalic acid, and 1,10-diaminodecane; terephthalic acid, 1,10-diaminodecane, and 1,12-diaminododecane; terephthalic acid, dodecanedioic acid, and 1,10-diaminodecane; terephthalic acid, sebacic acid, and 1,10-diaminodecane; terephthalic acid, adipic acid, and 1,10-diaminodecane; terephthalic acid, dodecanedioic acid, 1,10-diaminodecane, and hexamethylenediamine; terephthalic acid, adipic acid, 1,10-diaminodecane, and hexamethylenediamine; terephthalic acid, 1,10-diaminodecane, and hexamethylenediamine; terephthalic acid, adipic acid, 1,10-diaminodecane, and dodecanedioic acid; terephthalic acid, 1,10-diaminodecane, and 11-aminoundecanoic acid; terephthalic acid, 1,10-diaminodecane, and laurolactam; terephthalic acid, 1,10-diaminodecane, and caprolactam; terephthalic acid, 1,10-diaminodecane, and 2-methyl-1,5-petanediamine; terephthalic acid, adipic acid, 1,10-diaminodecane, and 2-methyl-1,5-petanediamine; terephthalic acid and 1,12-diaminododecane; terephthalic acid, isophthalic acid, and 1,12-diaminododecane; terephthalic acid, dodecanedioic acid, and 1,12-diaminododecane; terephthalic acid, sebacic acid, and 1,12-diaminododecane; terephthalic acid, adipic acid, and 1,1 2-diaminododecane; terephthalic acid, dodecanedioic acid, 1,12-diaminododecane, and hexamethylenediamine; terephthalic acid, adipic acid, 1,12-diaminododecane, and hexamethylenediamine; terephthalic acid, adipic acid, and 1,12-diaminododecane; hexamethylenediamine; terephthalic acid, adipic acid, 1,12-diaminododecane, and dodecanedioic acid; terephthalic acid, 1,12-diaminododecane, and 11-aminoundecanoic acid; terephthalic acid, 1,12-diaminododecane, and laurolactam; terephthalic acid, 1,12-diaminododecane, and caprolactam; terephthalic acid, 1,12-diaminododecane, and 2-methyl-1,5-petanediamine; and terephthalic acid, adipic acid, 1,12-diaminododecane, and 2-methyl-1,5-petanediamine.

Blends of two or more polyamides may be used in the present invention. The polyamides used in the present invention will preferably have melting points of about 270 to about 340° C. The polyamides more preferably have a melting point of about 280 to about 320° C. The polyamide comprises about 40 to about 95 weight percent, or preferably about 50 to about 80 weight percent, or more preferably about 60 to about 80 weight percent of the total composition.

The titanium dioxide used in the compositions may be any sort, but is preferably in the rutile form. The titanium dioxide comprises about 5 to about 40 weight percent, or preferably about 15 to about 30 weight percent, or more preferably about 20 to about 25 weight percent of the total composition.

The surface of the titanium dioxide particles will preferably be coated. The titanium dioxide will preferably be first coated with an inorganic coating and then an organic coating that is applied over the inorganic coating. The titanium dioxide particles may be coated using any method known in the art. Preferred inorganic coatings include metal oxides. Organic coatings may include one or more of carboxylic acids, polyols, alkanolamines, and/or silicon compounds.

Examples of carboxylic acids suitable for use as an organic coating include adipic acid, terephthalic acid, lauric acid, myristic acid, palmitic acid, stearic acid, polyhydroxystearic acid, oleic acid, salicylic acid, malic acid, and maleic acid. As used herein, the term “carboxylic acid” includes the esters and salts of the carboxylic acids.

Examples of silicon compounds suitable for an organic coating include, but are not limited to, silicates, organic silanes, and organic siloxanes, including organoalkoxysilanes, aminosilanes, epoxysilanes, mercaptosilanes, and polyhydroxysiloxanes Suitable silanes can have the formula RₓSi(R′)₄₋ₓ wherein R is a nonhydrolyzable aliphatic, cycloaliphatic, or aromatic group having from 1 to about 20 carbon atoms, and R′ is one or more hydrolyzable groups such as an alkoxy, halogen, acetoxy, or hydroxy group, and X is 1, 2, or 3.

Useful suitable silanes suitable for an organic coating include one or more of hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, octadecyltriethoxysilane, N-(2-aminoethyl) 3-aminopropylmethyldimethoxysilane, N-(2-aminoethyl) 3-aminopropyltrimethoxysilane, 3-aminopropyltriethoxysilane, 3-glycidoxypropyltrimethoxysilane, 3-glycidoxypropylmethyldimethoxysilane, 3-mercaptopropyltrimethoxysilane and combinations of two or more thereof. In other useful silanes, R has between 8 and 18 carbon atoms and R′ is one or more of chloro, methoxy, ethoxy, or hydroxy groups.

When present, the organic coating preferably comprises about 0.1 to about 10 weight percent, or more preferably about 0.5 to about 7 weight percent, or yet more preferably about 0.5 to about 5 weight percent-of the coated titanium dioxide.

Examples of suitable inorganic coatings include metal oxides and hydrous oxides, including oxides and hydrous oxides of silicon, aluminum, zirconium, phosphorous, zinc, rare earth elements, and the like. A preferred metal oxide is alumina.

The inorganic coating preferably comprises about 0.25 to about 50 weight percent, or more preferably about 1.0 to about 25 weight percent, or yet more preferably about 2 to about 20 weight percent of the coated titanium dioxide.

The compositions may optionally contain up to about 40 weight percent of one or more inorganic reinforcing agents and/or fillers. Example of suitable reinforcing agents include glass fibers and minerals, particularly fibrous minerals such as wollastonite. Examples of fillers include calcium carbonate, talc, mica, and kaolin. When present, the reinforcing agent and/or filler is preferably present in about 5 to about 40 weight percent, or more preferably about 10 to about 30 weight percent of the total composition.

The compositions may optionally contain up to about 3 weight percent of one or more oxidative stabilizers. Examples of suitable oxidative stabilizers include phosphite and hypophosphite stabilizers, hindered phenol stabilizers, hindered amine stabilizers, and aromatic amine stabilizers. When present, the oxidative stabilizers comprise about 0.1 to about 3 weight percent, or preferably about 0.1 to about 1 weight percent, or more preferably about 0.1 to about 0.6 weight percent, of the total weight of the composition.

The compositions may optionally further contain up to about 3 weight percent of ultraviolet light stabilizers. When present, the ultraviolet light stabilizers comprise about 0.1 to about 3 weight percent, or preferably about 0.1 to about 1 weight percent, or more preferably about 0.1 to about 0.6 weight percent, of the total weight of the composition.

The compositions are melt-mixed blends, wherein all of the polymeric components are well-dispersed within each other and all of the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

The LED assembly housing of the present invention may be in the form of a single piece or may be formed by assembling two or more subparts. When it is in the form of a single piece, it is prepared from the polyamide composition. When it is formed from two or more subparts, at least one of the parts is prepared from the polyamide composition. When it is formed from two or more subparts, one or more of those parts may be metal, ceramic, or a polymeric material other than the polyamide composition. The subparts may be connected mechanically, by gluing, or by overmolding a polymeric material over a metal or other polymeric part. The housing or housing subpart prepared from the composition used in the present invention may be formed from the polyamide composition by any suitable melt-processing method known to those skilled in the art, such as injection molding or the like. The housing may be overmolded over a metal (such as copper or silver-coated copper) lead frame that can be used to make an electrical connection to an LED inserted into the housing.

The housing preferably has a cavity in the portion of the housing that surrounds the LED, which serves to reflect the LED light in the outward direction and towards a lens, if one is present. The cavity may be in a cylindrical, conical, parabolic or other curved form, and preferably has a smooth surface. Alternatively, the walls of the cavity may be parallel or substantially parallel to the diode. A lens may be formed over the diode cavity and may comprise an epoxy or silicone material.

The housings of the present invention may be incorporated into LED assemblies used in applications such as traffic signals, large area displays (including video displays), video screens, interior and exterior lighting, cellular telephone display backlights, automotive displays, vehicle brake lights, vehicle head lamps, laptop computer display backlights, pedestrian floor illumination, and flashlights.

### EXAMPLES

The compositions of Example 1 and Comparative Example 1 were prepared by melt blending the ingredients shown in Table 1 in a Buss kneader using a screw speed of about 250 rpm and a melt temperature of about 340° C. In Table 1, “Polyamide A” refers to a polyamide having repeat units derived from 1,10-diaminodecane and about 90 mole percent terephthalic acid and about 10 mole percent of dodecanedioic acid, wherein the mole percentages are based on the total amount of terephthalic acid and dodecanedioic acid. Polyamide A has a first melting point of about 303° C. as determined by differential scanning calorimetry (DSC) following ISO method 3146 and scanning at 10° C./min. “Polyamide B” refers to a polyamide having repeat units derived from hexamethylenediamine, terephthalic acid, and adipic acid and having a first melting point of about 310° C. as determined by DSC as described above. “Stabilizers” refers to a blend containing about 20 weight parts Irgafas® 12; about 20 weight parts Irganox® 1098; about 20 weight parts Tinuvin® 360; and about 30 weight parts Chimassorb® 119FL. All stabilizers are supplied by Ciba Specialty Chemicals Corp, Tarrytown, N.Y.

The compositions were molded into ISO tensile bars according to ISO method 527-1/2 using a mold temperature of about 100° C. and tensile modulus was determined using the same method. The results are shown in Table 1.

The whiteness index was determined for each composition using ASTM-E313. Results were measured on prepared as described above that were either dry-as-molded (DAM) had been heat aged in air for 2 hours at 150° C., 180° C., and 200° C. The results are shown in Table 1. Higher numbers indicate better whiteness.

Adhesion of the compositions to epoxy resin was determined as follows: A metal ring having a diameter of about 1 cm and a thickness of about 2 mm was placed on the surface of one of the wide tabs of an ISO tensile bar molded as described above. The ring was filled with a two-part liquid epoxy and the bars were placed in an oven set at 180° C. for 1 hour to cure the epoxy. The ring was then removed, leaving a cylinder of epoxy affixed to the tensile bar. The bars were conditioned by placing them in an oven and holding them sequentially at 45° C., 23° C., and 125° C. for 1 hour at each temperature. This conditioning procedure was run three times. After conditioning, the adhesion of the epoxy resin to the tensile bar was tested by clamping the wide portion of the tensile bar that did not contain the molded epoxy in a tensile testing machine. A specially-adapted rig was attached to the epoxy cylinder and the shear force necessary to detach the epoxy cylinder from the bar was measured. The results are reported in Table 1 under the heading of “Adhesion.”

Blistering resistance was determined using a dip soldering test. Bars having a thickness of 0.8 mm were molded according to according to UL Test No. UL-94; 20 mm Vertical Burning Test from the compositions of Example 1 and Comparative Example 1 and were dipped in molten solder to a depth of 15 mm in a Rhesca Co. Ltd. Solder Checker SAT-5100 for 5 or 10 seconds. The bars were used dry-as-molded (DAM) or after conditioning for 168 hours at 85° C. and 85 percent relative humidity (RH). The solder was at a temperature of 255, 260 or 265° C. Upon being removed from the solder, the bars were inspected for surface blisters. The results are given in Table 2.

TABLE 1

| | | Comparative |
|---|---|---|
| | Example 1 | Ex. 1 |
| Polyamide A | 59.1 | — |
| Polyamide B | — | 59.1 |
| Glass fibers | 20 | 20 |
| Titanium dioxide | 20 | 20 |
| Stabilizers | 0.9 | 0.9 |
| Tensile modulus (GPa) | 7.2 | 8.4 |
| Whiteness index | | |
| Before heat aging | 43.0 | 40.7 |
| Aged at 150° C. for 2 h | 29.4 | 22.6 |
| Aged at 180° C. for 2 h | 20.4 | 13.7 |
| Aged at 200° C. for 2 h | 9.4 | 2.5 |
| Adhesion (N/mm) | 611 | 560 |

Ingredient quantities are given in weight percent based on the total weight of the composition.

TABLE 2

| Solder temp | | Time | | Comparative |
|---|---|---|---|---|
| (° C.) | Conditioning | (sec) | Example 1 | Ex. 1 |
| 265 | DAM | 10 | ◯ | ◯ |
| 265 | 85° C./85% RH/168 h | | ◯ | XX |
| 260 | | | ◯ | XX |
| 255 | | | ◯ | ◯ |
| 265 | DAM | 5 | ◯ | ◯ |
| 265 | 85° C./85% RH/168 h | | ◯ | XX |
| 260 | | | ◯ | X |
| 255 | | | ◯ | ◯ |

[“◯” denotes that no blisters were observed; “X” denotes that blisters having a diameter of less than about 5 mm were observed; and “XX” denotes that blisters having a diameter of greater than about 5 mm were observed.]

The compositions of Example 1 and Comparative Example 1 are molded into light emitting diode assembly housings that contain epoxy lenses. The housings of Example 1 have improved resistance to surface blistering when the housing are welded to circuit boards, better adhesion to the epoxy lens, and better whiteness/reflectivity than the housings than the housings of Comparative Example 1.

What is claimed is:

1. A light-emitting diode assembly housing comprising a polyamide composition, comprising:
(a) about 40 to about 95 weight percent of at least one polyamide having a melting point of greater than about 270° C. and comprising repeat units derived from:
(i) dicarboxylic acid monomers comprising terephthalic acid, and, optionally, one or more additional aromatic and/or aliphatic dicarboxylic acids;
(ii) diamine monomers comprising one or more aliphatic diamines having 10 to 20 carbon atoms, and, optionally, one or more additional diamines; and
(b) optionally, one or more aminocarboxylic acids and/or lactams;
(c) about 5 to about 40 weight percent of titanium dioxide;
(d) 0 to about 40 weight percent of at least one inorganic reinforcing agent or filler; and
(e) 0 to about 3 weight percent of at least one oxidative stabilizer,
wherein the weight percentages are based on the total weight of the composition.

2. The housing of claim 1, wherein the polyamide is present in about 50 to about 80 weight percent, based on the total weight of the composition.

3. The housing of claim 1, wherein the polyamide is present in about 60 to about 80 mole percent, based on the total weight of the composition.

4. The housing of claim 1, wherein the titanium dioxide is present in about 15 to about 30 weight percent, based on the total weight of the composition.

5. The housing of claim 1, wherein the titanium dioxide is present in about 20 to about 25 weight percent, based on the total weight of the composition.

6. The housing of claim 1, wherein the titanium dioxide has an inorganic coating and an organic coating.

7. The housing of claim 6, wherein the inorganic coating is a metal oxide.

8. The housing of claim 6, wherein the organic coating is one or more of carboxylic acids, polyols, alkanolamines, and/or silicon compounds.

9. The housing of claim 8, wherein the carboxylic acid is one or more of adipic acid, terephthalic acid, lauric acid, myristic acid, palmitic acid, stearic acid, polyhydroxystearic acid, oleic acid, salicylic acid, malic acid, and maleic acid.

10. The housing of claim 8, wherein the silicon compound is one or more of silicates, organic silanes, and organic siloxanes, including organoalkoxysilanes, aminosilanes, epoxysilanes, mercaptosilanes, and polyhydroxysiloxanes.

11. The housing of claim 10, wherein the silane is one or more silanes selected from: hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, octadecyltriethoxysilane, N-(2-aminoethyl) 3-aminopropylmethyldimethoxysilane, N-(2-aminoethyl) 3-aminopropyltrimethoxysilane, 3-aminopropyltriethoxysilane, 3-glycidoxypropyltrimethoxysilane, 3-glycidoxypropylmethyldimethoxysilane, and 3-mercaptopropyltrimethoxysilane.

12. The housing of claim 1, wherein the polyamide is one or more polyamides derived from: terephthalic acid and 1,10-diaminodecane; terephthalic acid, isophthalic acid, and 1,10-diaminodecane; terephthalic acid, 1,10-diaminodecane, and 1,12-diaminododecane; terephthalic acid, dodecanedioic acid, and 1,10-diaminodecane; terephthalic acid, sebacic acid, and 1,10-diaminodecane; terephthalic acid, adipic acid, and 1,10-diaminodecane; terephthalic acid, dodecanedioic acid, 1,10-diaminodecane, and hexamethylenediamine; terephthalic acid, adipic acid, 1,10-diaminodecane, and hexamethylenediamine; terephthalic acid, 1,10-diaminodecane, and hexamethylenediamine; terephthalic acid, adipic acid, 1,10-diaminodecane, and dodecanedioic acid; terephthalic acid, 1,10-diaminodecane, and 11-aminoundecanoic acid; terephthalic acid, 1,10-diaminodecane, and laurolactam; terephthalic acid, 1,10-diaminodecane, and caprolactam; terephthalic acid, 1,10-diaminodecane, and 2-methyl-1,5-petanediamine; terephthalic acid, adipic acid, 1,10-diaminodecane, and 2-methyl-1,5-petanediamine; terephthalic acid and 1,12-diaminododecane; terephthalic acid, isophthalic acid, and 1,12-diaminododecane; terephthalic acid, dodecanedioic acid, and 1,12-diaminododecane; terephthalic acid, sebacic acid, and 1,12-diaminododecane; terephthalic acid, adipic acid, and 1,12-diaminododecane; terephthalic acid, dodecanedioic acid, 1,12-diaminododecane, and hexamethylenediamine; terephthalic acid, adipic acid, 1,12-diaminododecane, and hexamethylenediamine; terephthalic acid, adipic acid, and 1,12-diaminododecane; hexamethylenediamine; terephthalic acid, adipic acid, 1,12-diaminododecane, and dodecanedioic acid; terephthalic acid, 1,12-diaminododecane, and 11-aminoundecanoic acid; terephthalic acid, 1,12-diaminododecane, and laurolactam; terephthalic acid, 1,12-diaminododecane, and caprolactam; terephthalic acid, 1,12-diaminododecane, and 2-methyl-1,5-petanediamine; and terephthalic acid, adipic acid, 1,12-diaminododecane, and 2-methyl-1,5-petanediamine

13. The housing of claim 1, wherein the inorganic filler and/or reinforcing agent is one or more selected from glass fibers, wollastonite, calcium carbonate, talc, mica, and kaolin.

14. The housing of claim 1, wherein the inorganic filler is present in about 5 to about 40 weigh percent, based on the total weight of the composition.

15. The housing of claim 1, wherein the oxidative stabilizer is one or more selected from phosphite stabilizers, hypophosphite stabilizers, hindered phenol stabilizers, hindered amine stabilizers, and aromatic amine stabilizers.

16. The housing of claim 1, wherein the oxidative stabilizer is present in about 0.1 to about 3 weight percent, based on the total weight of the composition.

17. The housing of claim 1, wherein the polyamide composition further comprises about 0.1 to about 3 weight percent, based on the total weight of the composition, of ultraviolet light stabilizers.

18. A light-emitting diode assembly comprising the housing of claim 1.
